(19) United States
(12) Patent Application Publication
(10) Pub. No.: US 2017/0055082 A1
(43) Pub. Date: Feb. 23, 2017

(54) SPEAKER

(71) Applicant: INNOVATION SOUND TECHNOLOGY CO., LTD., Shenzhen, Guangdong (CN)

(72) Inventor: Shunming YUEN, Hong Kong (CN)

(21) Appl. No.: 14/763,051

(22) PCT Filed: Jan. 23, 2013
(86) PCT No.: PCT/CN2013/070870

§ 371 Date: Jul. 23, 2015

(51) Int. Cl. H04R 7/18; H04R 9/02; H04R 7/12; H04R 9/06

(52) U.S. Cl. CPC H04R 7/18; H04R 9/06; H04R 9/025; H04R 7/122; H04R 2307/207

(57) ABSTRACT

The utility model relates to a type of speaker which comprises the speaker body and the vibrating membrane for speakers fastened on the speaker body, wherein the latter comprises: the first and the second diaphragm leaf, with the former comprising the circular top and the first edge extended along the periphery of the circular top, while the latter comprising the hollow part and the second edge extended along the periphery of the hollow part, wherein, the said first and the second edge are enclosed to form a hollow cavity. Application of the speaker of the utility model could reinforce the ultra-low bass level of the speaker to obtain ever clearer sound. Further, better flexural behavior and a more stable structure of the vibrating membrane for speakers can be realized

### FIELD OF THE INVENTION

The utility model relates to a type of speaker, more specifically, a type of speaker in which an ultra-low bass level could be added to produce clearer sound.

### BACKGROUND OF THE INVENTION

Speakers of the prior art feature unreasonable structure design due to the problems as follows:

1. The vibrating membrane for speakers is prone to bending or distortion, which would result in a poor bass level.

2. The stability is poor and deformation easily occurs, which would result in a short service life of the product.

### Description of the Utility Model

The technical problem to be solved by the utility model is to provide a type of speaker in which an ultra-low bass level could be added to produce clearer sound.

Another technical problem to be solved by the utility model is to render better flexural behavior and a more stable structure of the vibrating membrane for speakers to wane down the liability of deformation.

To solve the technical problem, a type of speaker is provided in the embodiments of the utility model, which comprises the speaker body and the vibrating membrane for speakers fastened on the speaker body, wherein the latter comprises: the first and the second diaphragm leaf, with the former comprising the circular top and the first edge extended along the periphery of the circular top while the latter comprising the hollow part and the second edge extended along the periphery of the hollow part, wherein, the first and the second edge are enclosed to form a hollow cavity; the speaker body comprises a stand, a U-yoke, a magnet, a fastener and a voice coil, wherein the U-yoke is fastened in the middle of the stand and a cavity is disposed in the middle of the U-yoke; the magnet, fastener and voice coil are successively connected and fastened in the cavity.

Wherein, the first diaphragm leaf and/or the second diaphragm leaf are of a single membrane structure. Wherein, the first edge and/or the second edge are designed into a ringlike protruding structure. Wherein, the first edge and the second edge are in an opposite direction of protrusion. Wherein, the first edge and/or the second edge are fastened on the stand.

Wherein, the first diaphragm leaf and/or the second diaphragm leaf are of a single membrane structure.

Another technical scheme to be adopted to solve the technical problem is to: The speaker comprises: the speaker body and the vibrating membrane for speakers fastened on the speaker body, wherein the latter comprises: the first and the second diaphragm leaf, with the former comprising the circular top and the first edge extended along the periphery of the circular top while the latter comprising the hollow part and the second edge extended along the periphery of the hollow part, wherein, the first and the second edge are enclosed to form a hollow cavity; the first diaphragm leaf and/or the second diaphragm leaf are of a single membrane structure.

Wherein, the speaker body also comprises a stand on which the first edge and/or the second edge are fastened. Wherein, the speaker body comprises as well a U-yoke, a magnet, a fastener and a voice coil, wherein the said U-yoke is fastened in the middle of the stand and a cavity is disposed in the middle of the U-yoke; the magnet, fastener and voice coil are successively connected and fastened in the cavity.

Wherein, the first edge and/or the second edge are designed into a ringlike protruding structure.

Wherein, the first edge and the second edge are in an opposite direction of protrusion.

Another technical scheme to be adopted to solve the technical problem is to: The speaker comprises: the speaker body and the vibrating membrane for speakers fastened on the speaker body, wherein the latter comprises: the first and the second diaphragm leaf, with the former comprising the circular top and the first edge extended along the periphery of the circular top while the latter comprising the hollow part and the second edge extended along the periphery of the hollow part, wherein, the first and the second edge are enclosed to form a hollow cavity.

Wherein, the speaker body also comprises a stand on which the first edge and/or the second edge are fastened.

Wherein, the speaker body comprises as well a U-yoke, a magnet, a fastener and a voice coil, wherein the said U-yoke is fastened in the middle of the stand and a cavity is disposed in the middle of the U-yoke; the magnet, fastener and voice coil are successively connected and fastened in the cavity.

Wherein, the first diaphragm leaf and/or the second diaphragm leaf are of a single membrane structure.

Wherein, the first edge and/or the second edge are designed into a ringlike protruding structure.

Wherein, the first edge and the second edge are in an opposite direction of protrusion.

Application of the speaker of the utility model could render the beneficial effects as follows: since the first and the second diaphragm leaf are disposed on the vibrating membrane for speakers, with the former comprising the circular top and the first edge extended along the periphery of the circular top while the latter comprising the hollow part and the second edge extended along the periphery of the hollow part, the first and the second edge are enclosed to form a hollow cavity which can maintain the form of the two diaphragm leaves. This is to make the two diaphragm leaves less prone to neither bending nor deformation, maintain and reinforce an ultra-low bass level of the speaker, render better flexural behavior of the double-layer membrane structure and a more stable structure of the speaker to wane down the liability of deformation, thereby extending the service life and promoting the quality of the product.

### BRIEF INTRODUCTION OF THE DRAWINGS

FIG. 1 is a schematic view of the blasting structure of the speaker in the embodiments of the utility model.

FIG. 2 is a top schematic view of the assembled speaker in the embodiments of the utility model.

FIG. 3 is a section schematic view of the speaker in the C-C direction as shown in FIG. 2 in the embodiments of the utility model.

### DETAILED DESCRIPTION OF THE PREFERRED EMBODIMENTS

The preferred embodiments of the invention are described hereinafter in reference to the accompanying drawings.

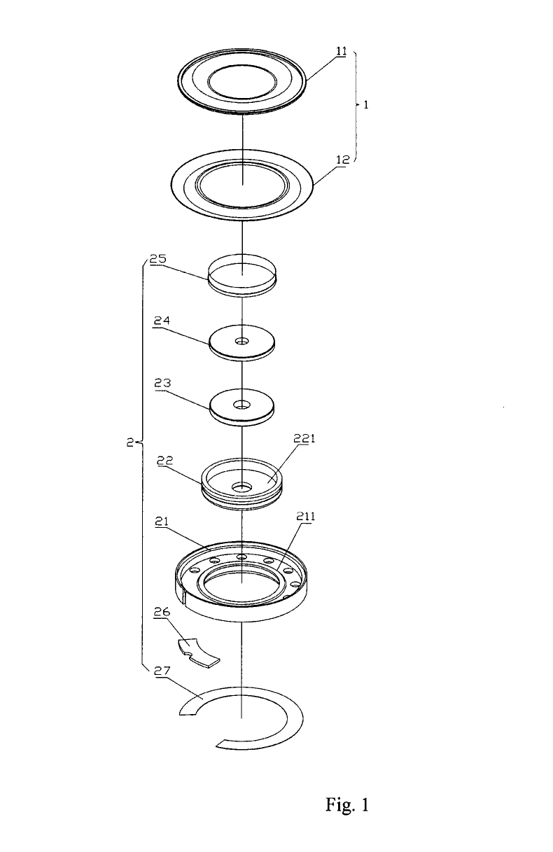

FIG. 1 to FIG. 3 show an embodiment of the speaker of the utility model.

FIG. 1 shows a schematic view of the blasting structure of the speaker in the embodiments of the utility model which comprises: the vibrating membrane 1 for speakers and the speaker body 2, wherein the former is fastened on the latter.

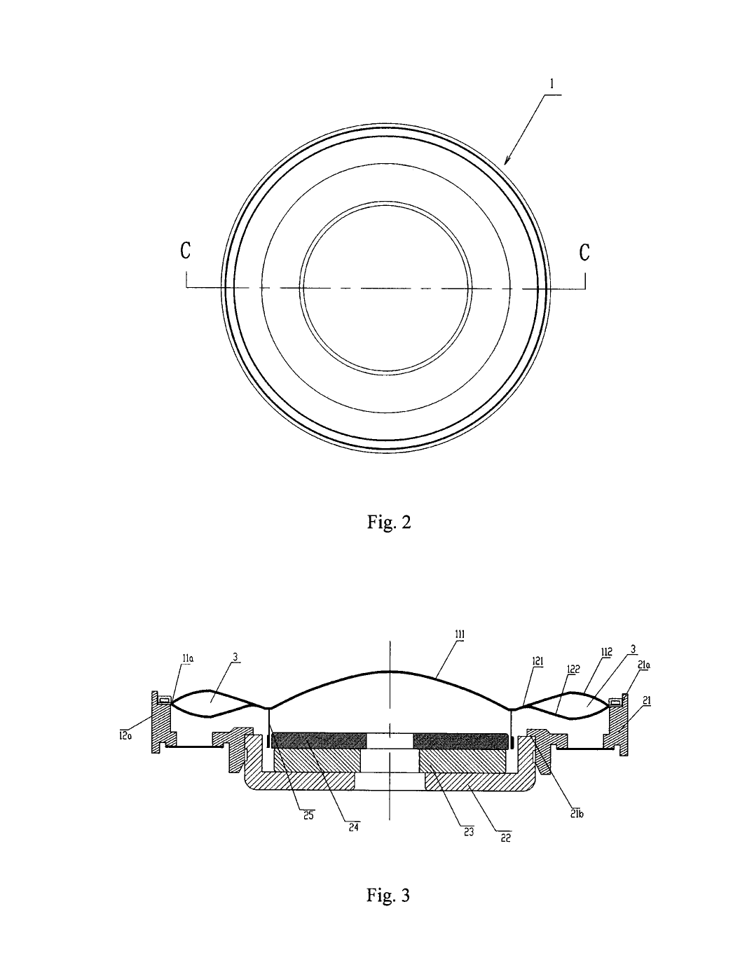

FIG. 2 and FIG. 3 respectively show a top schematic view of the assembled speaker in the embodiments of the utility model and a section schematic view of the speaker in the C-C direction as shown in FIG. 2 in the embodiments of the utility model, wherein: the vibrating membrane 1 for speakers comprises the first diaphragm leaf 11 and the second diaphragm leaf 12, with the former comprising the circular top 111 and the first edge 112 extended along the periphery of the circular top 111,

while the latter comprises the hollow part 121 and the second edge 122 extended along the periphery of the hollow part 121, wherein the first edge 112 and the second edge 122 are enclosed to form a hollow cavity 3.

In the embodiment, the first diaphragm leaf 11 and the second diaphragm leaf 12 are designed into a single membrane structure. The single membrane is of a multi-layer structure, for example, it could comprise a bottom layer used to reinforce the low frequency, a surface disposed on the said bottom layer, a composite metal layer used to ensure vibration uniformity, or an intermediate composite layer used for HF compensation disposed between the said bottom layer and the said composite metal layer.

It could be understood such that, the number of layers and specific function of the single membrane might be adjusted based on the practical functional needs.

The hollow cavity 3 is disposed to: add the second diaphragm leaf 12 on the basis of the first diaphragm leaf 11 so that the two diaphragm leaves are prone to neither bending nor distortion under an external force due to vibration and a ultra-low bass level of the speaker is maintained; in addition, a hollow cavity 3 can be formed between the two diaphragm leaves to further reinforce the ultra-low bass level of the speaker.

In addition, the speaker with the two-diaphragm-leaf structure is characterized in that, a hollow cavity 3 is formed by fastening the two diaphragm leaves to replace the traditional single-diaphragm-leaf structure which needs to dispose a pattern or figure on the diaphragm leaf, so that the treble scope and sound of the speaker is made even clearer.

Preferably, the first edge 112 and the second edge 122 are designed into a ringlike protruding structure which is conductive to fastening the two diaphragm leaves 11 and 12 on the speaker body 2. In addition, the first edge 112 and the second edge 122 are in an opposite direction of protrusion to make the space area of the hollow cavity 3 formed by assembling the two diaphragm leaves 11 and 12 even bigger, thereby reinforcing the ultra-low bass level of the speaker.

Further, the first diaphragm leaf 11 and the second diaphragm leaf 12 are fastened by the speaker body 2. Specifically, the speaker body 2 comprises a stand 21, a U-yoke 22, a magnet 23, a fastener 24, a voice coil 25, a PCB board 26 and a piece of toning paper 27.

The stand 21 is a circular frame structure with a through hole 211, wherein the ringlike edge 21a at its top opening end fits the size of the first diaphragm leaf 11 and the second diaphragm leaf 12 and is used to fasten these two diaphragm leaves; the ringlike edge 21b at its bottom opening end fits the size of the Y-yoke 22 and is used to fasten the U-yoke.

On the occasion of concrete application, edge 21a of the stand 21 could fasten the first edge 112 of the said first diaphragm leaf 11 while the second edge 122 of the second diaphragm leaf 12 is fastened on the first edge 112 of the first diaphragm leaf 11 (applied by fastening the ringlike protrusion on the first edge 112), or the two edges 112 and 122 of the two diaphragm leaves 11 and 12 could be fixed on edge 21a of the stand 21 (applied by fastening the ringlike protrusion on the first edge 112 and the second edge 122), as long as it is such that the first edge 112 and the second edge 122 are enclosed to form a hollow cavity 3.

The U-yoke is disc-like and is disposed a hollow cavity 221 in which the magnet 23 and the fastener 24 are connected by fastening. The fastener in the embodiment is designed into a spring washer. The voice coil 25 which is a thin-walled ring with an opening at both ends is disposed at the junction of the two diaphragm leaves 11 and 12 above the fastener 24.

Preferably, a piece of PCB paper 26 and toning paper 27 are disposed by fastening at the bottom of the stand 21.

Application of the speaker of the utility model could be such that, since the first and the second diaphragm leaf are disposed on the vibrating membrane for speakers, with the former comprising the circular top and the first edge extended along the periphery of the circular top while the latter comprising the hollow part and the second edge extended along the periphery of the hollow part, the first and the second edge are enclosed to form a hollow cavity which can maintain the form of the two diaphragm leaves. This is to make the two diaphragm leaves less prone to neither bending nor deformation, maintain and reinforce an ultra-low bass level of the speaker, render better flexural behavior of the double-layer membrane structure and a more stable structure of the speaker to wane down the liability of deformation, thereby extending the service life and promoting the quality of the product.

Only the preferred embodiments of the invention are disclosed which surely are not intended to limit the scope of protection of the invention. Therefore, equivalent changes made in accordance with the Claims of the invention are still covered within the scope of the invention.

1. A type of speaker is disclosed which comprises: the speaker body and the vibrating membrane for speakers fastened on the speaker body, wherein the latter comprises: the first and the second diaphragm leaf, with the former comprising the circular top and the first edge extended along the periphery of the circular top, while the latter comprising the hollow part and the second edge extended along the periphery of the hollow part, wherein, the said first and the second edge are enclosed to form a hollow cavity.
The said speaker body comprises a stand, a U-yoke, a magnet, a fastener and a voice coil, wherein the said U-yoke is fastened in the middle of the said stand and a cavity is disposed in the middle of the said U-yoke;
The said magnet, fastener and voice coil are successively connected and fastened in the cavity.

2. The speaker according to claim 1 is characterized in that the said first diaphragm leaf and/or the said second diaphragm leaf are of a single membrane structure.

3. The speaker according to claim 1 is characterized in that the said first edge and/or the said second edge are of a ringlike protruding structure.

4. The speaker according to claim 3 is characterized in that the said first edge and the said second edge are in an opposite direction of protrusion.

5. The speaker according to claim 4 is characterized in that the said first edge and/or the said second edge are fastened on the said stand.

6. The speaker according to claim 5 is characterized in that the said first diaphragm leaf and/or the said second diaphragm leaf are of a single membrane structure.

7. A type of speaker is disclosed which comprises: the speaker body and the vibrating membrane for speakers fastened on the speaker body, wherein the latter comprises: the first and the second diaphragm leaf, with the former comprising the circular top and the first edge extended along the periphery of the circular top, while the latter comprising the hollow part and the second edge extended along the periphery of the hollow part, wherein, the said first and the second edge are enclosed to form a hollow cavity.
The said first diaphragm leaf and/or the said second diaphragm leaf are of a single membrane structure.

8. The speaker according to claim 7 is characterized in that, the said speaker body comprises a stand on which the said first edge and/or the said second edge are fastened.

9. The said speaker according to claim 8 is characterized in that, the said speaker body comprises as well a U-yoke, a magnet, a fastener and a voice coil, wherein the said U-yoke is fastened in the middle of the said stand and a cavity is disposed in the middle of the said U-yoke;
The said magnet, fastener and voice coil are successively connected and fastened in the cavity.

10. The speaker according to claim 8 is characterized in that the said first edge and/or the said second edge are of a ringlike protruding structure.

11. The speaker according to claim 10 is characterized in that the said first edge and the said second edge are in an opposite direction of protrusion.

12. A type of speaker is disclosed which comprises: the speaker body and the vibrating membrane for speakers fastened on the speaker body, wherein the latter comprises: the first and the second diaphragm leaf, with the former comprising the circular top and the first edge extended along the periphery of the circular top, while the latter comprising the hollow part and the second edge extended along the periphery of the hollow part, wherein, the said first and the second edge are enclosed to form a hollow cavity.

13. The speaker according to claim 12 is characterized in that, the said speaker body comprises a stand on which the said first edge and/or the said second edge are fastened.

14. The said speaker according to claim 13 is characterized in that, the said speaker body comprises as well a U-yoke, a magnet, a fastener and a voice coil, wherein the said U-yoke is fastened in the middle of the said stand and a cavity is disposed in the middle of the said U-yoke;
The said magnet, fastener and voice coil are successively connected and fastened in the cavity.

15. The speaker according to claim 14 is characterized in that the said first diaphragm leaf and/or the said second diaphragm leaf are of a single membrane structure.

16. The speaker according to claim 15 is characterized in that the said first edge and/or the said second edge are of a ringlike protruding structure.

17. The speaker according to claim 16 is characterized in that the said first edge and the said second edge are in an opposite direction of protrusion.
